(19) United States
(12) Patent Application Publication
(10) Pub. No.: US 2014/0073164 A1
(43) Pub. Date: Mar. 13, 2014

(54) HIGH-DENSITY CONNECTOR

(71) Applicants: Nicolas Convert, Gex (FR); Jean-Marie Buchilly, Bottens (CH); Stéphane Rohrbach, Ballens (CH)

(72) Inventors: Nicolas Convert, Gex (FR); Jean-Marie Buchilly, Bottens (CH); Stéphane Rohrbach, Ballens (CH)

(73) Assignee: FISCHER CONNECTORS HOLDING S.A., St.-Prex (CH)

(21) Appl. No.: 14/114,664

(22) PCT Filed: Apr. 23, 2012
(86) PCT No.: PCT/IB2012/052031

§ 371 Date: Oct. 29, 2013

(30) Foreign Application Priority Data
Apr. 29, 2011 (CH) 00731/11

(51) Int. Cl. H01R 13/03; H01R 24/84; H01R 43/16

(52) U.S. Cl. CPC H01R 13/035; H01R 43/16; H01R 24/84
USPC 439/284; 29/879; 439/884

(57) ABSTRACT

The invention relates to a connector which includes basic parts that can be assembled and nested together, forming a high-density connector technology for hermaphroditic contacts.

### TECHNICAL FIELD

The present invention relates to electrical connector technology. More specifically, the present invention relates to the connectors with a high density of contacts, for example of electrical contacts.

### STATE OF THE ART

The products named Tyco Nanonics, Omnetics Nano metal shell, Glenair, Souriau Micro relate to circular connectors comprising up to 44 contacts and are known in the prior art.

Another example of high-density connector is known from the Tyco Electronics Corporation patent U.S. Pat. No. 7,632,126. This connector notably comprises a support plate which bears a plurality of electrical contacts which are aligned. The male part of the connector can contain a number of such plates, for example four, which are aligned in parallel and, correspondingly, the female part comprises receptacles which are also aligned in parallel, said receptacles containing contacts.

### SUMMARY OF THE INVENTION

The aim of the invention is to improve the known systems.

More specifically, one aim of the invention is to propose a connector formed, for example, by an assembly of parts (for example made of plastic) that are partially metalized to allow for an extreme contact densification. The expression “contact density” should be understood to mean the number of contacts in relation to the overall bulk of the connector.

These days, the traditional contact manufacturing and assembly methods are reaching the physical limits for guaranteeing a quality that is perceived as average. Our own competition and experimental studies have shown that, to maintain a high quality level according to our standards, an alternative to the conventional methods was needed.

Thus, there is a first barrier to be overcome: how to maintain an industrially high quality level.

The connector system market offers a multitude of high-density connectors, such as the rectangular connector which supports the “HDMI” protocol for example. However, all these connectors, mainly rectangular, are constructed for “indoor” applications. They therefore offer little robustness to exposure to the outdoor environment, with an IP68 ingress protection function for example. It is possible to encapsulate them in order to make them more robust. A packaging notably increases the bulk, and the ingress protection is a function that is more difficult to guarantee on a rectangular design than a circular design, thus losing the advantage of a high contact density and simple functional design.

Therefore, there is a second barrier to be overcome: How to preserve a small footprint and a high contact density.

One option would be to manufacture with methods requiring significant investments, such as stamping, for example, which is widely used in the connector systems applied to consumer products. These methods therefore require applications that allow for a flow of large volumes which are more difficult to objectify in the industrial market.

There is therefore a third barrier to be overcome: How to rationalize the manufacturing to remain competitive.

To sum up, there are three challenges to be met:
1) Miniaturization
2) Functionality
3) Rationalization

To meet these challenges, the idea is to apply, in the first step of the connector manufacturing process according to the invention, a novel method for metalizing the surface by laser activation of the plastic, in the context of the MID (Molded Interconnect Device) technology.

This method consists in activating a plastic by laser, a technology known by the term LPKF-LDS (a technology of the company LPKF). This technology is described for example in the publication EP 1 191 127, the content of which is incorporated for reference in the present application. The next step is the metallization of the parts activated by the LPKF-LDS method by conventional galvanic bath methods. The final step is the assembly of the components.

The LPKF-LDS method provides the following advantages
1) Simple and inexpensive metallization of non-planar surface, impossible to obtain in conventional deposition or etching methods
2) Reduction of the number of parts to be manufactured
3) Significant reduction of the size of the parts while retaining high-quality functionalities.

One of the ideas of the present invention is to design parts that allow for a shrewd assembly and a particular design of the interpenetrated parts to form a high-density connector system that is simple to manufacture, that allows for a rationalization of the costs and makes it possible to obtain high quality functions which are these days difficult to obtain by conventional methods.

The duly formed connector is intended to be wired and to ensure a transfer of electricity.

### BRIEF DESCRIPTION OF THE DRAWINGS

The invention will be better understood from the description of embodiments and the figures in which

FIG. 1 shows a perspective view of the basic part;

FIG. 2 shows a perspective view of the metallic coating;

FIG. 3 shows a perspective view of the assembly formed from two identical basic parts;

FIG. 4 shows a perspective view of the assembled electrical connector;

FIG. 5 shows a cross-sectional view of the electrical connector encapsulated in a metal housing;

FIG. 6 shows a perspective view of the contact block;

FIG. 7 shows a perspective view of another embodiment of the invention, and

FIG. 8 shows a perspective view of another embodiment of the invention.

### DETAILED DESCRIPTION

In the following description, the elements that are identical or similar will be identified by means of the same numeric references in the interests of simplification.

According to the present invention, in one embodiment, a support allowing for a high-density electrical connector is formed, preferably using two identical basic parts (for example made of plastic).

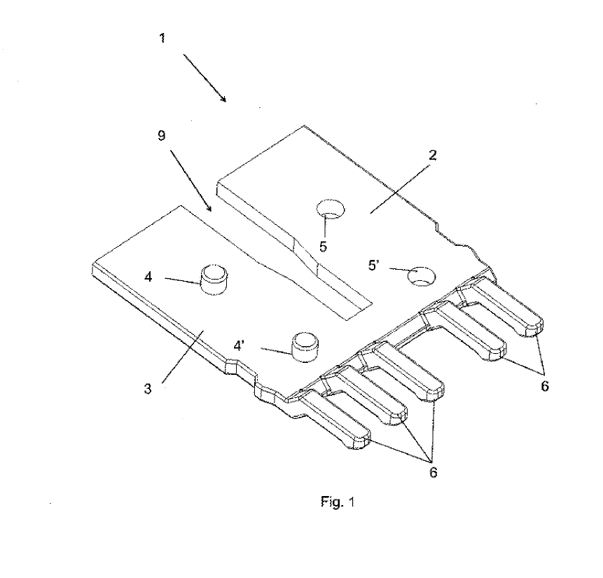

FIG. 1 shows a general view from above of a basic part 1. This basic part 1 comprises, for example, two tabs 2, 3 that each have at least one stud 4, 4′ and one alignment cavity 5, 5′, the use of which will be explained later. At the end of the tabs 2, 3, there are contact fingers 6. In its “crude” state, the part 1 is, for example, made of plastic and it then undergoes a laser activation step in order to form the electrical contact tracks according to the method of the company LPKF-LDS mentioned above. Obviously, any appropriate material for the implementation of this method and the application of the present invention can be envisaged.

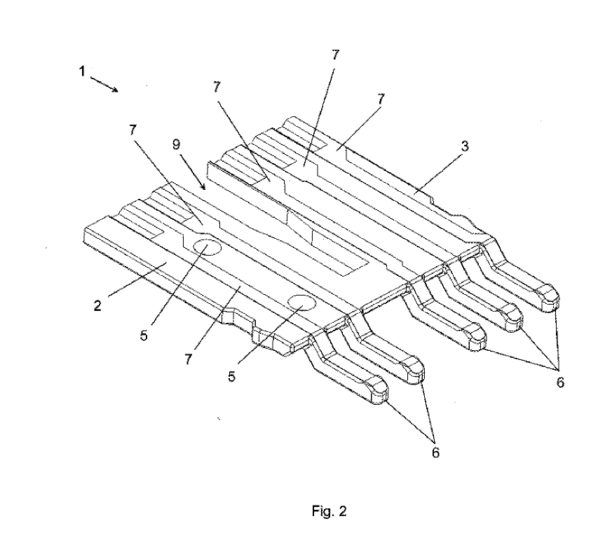

FIG. 2 shows a general view from above. According to this embodiment of the invention, a metal coating has been deposited from one end to the other of the basic part 1. This coating forms a number of conductive and independent tracks 7 on the basic part by virtue of the laser activation method of the company LPKF-LDS.

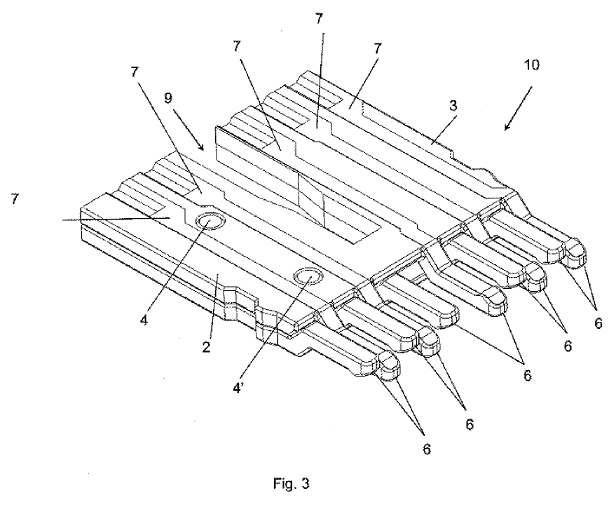

As will be understood from FIGS. 1 and 2, given the asymmetrical arrangement of the fingers 6 (one tab 2 with two fingers 6, and the other tab 3 with three fingers 6), by turning over the part 1, it is possible to assemble two parts 1 together to obtain the configuration illustrated in FIG. 3 in which the fingers 6 are “nested” as illustrated, one alongside the other to form one element with ten adjacent contacts 6.

Furthermore, since the metalized tracks are present on the non-contiguous faces of the parts 1, there is no electrical contact between them and the isolation is guaranteed. Finally, through the nesting of the studs 4, 4′ and the cavities 5, 5′, a stable and aligned mounting of the two parts 1 is obtained.

At the limit, it is also possible to use only a single part 1 as illustrated in FIG. 2, but in this case contact density will be lost.

As indicated above, FIG. 3 shows a general view of a part 10 assembled from two basic parts 1. By construction, the two basic parts 1 are identical and assembled to form one part which contains conductive tracks on both its faces.

The electrical connection to a cable or another plug (straight or bent) can then be made on the rear side of the parts 1, that is to say, on the side away from the contacts 6.

This assembled part can be mounted in a support (rectangular or cylindrical) to form a connector and, as will be understood, it forms a hermaphroditic element which can be placed both in the male part and the female part of the connector.

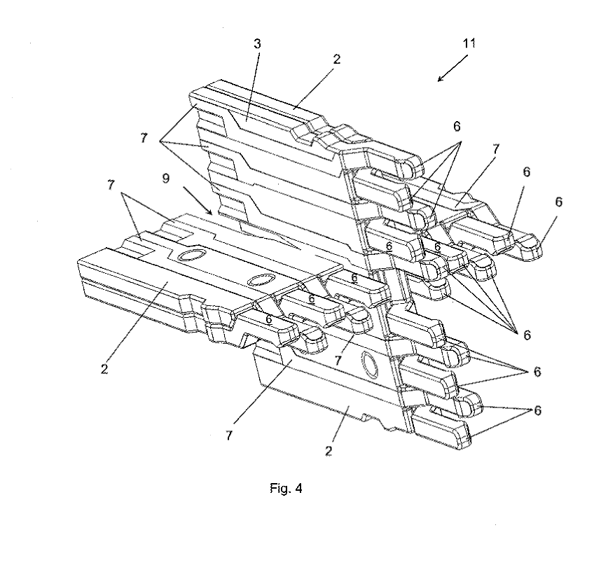

In another embodiment, the density of the electrical contacts can be increased (for example doubled) by mounting two parts in a cruciform nesting 11 which is illustrated in FIG. 4. This nesting can be done by using the slot 9 of the parts 1 (see FIGS. 1 and 2).

Alternatively, such a geometrical configuration could be produced directly, without assembly, by an appropriate method, for example molding.

The advantage of this configuration is particularly evident for a cylindrical connector because the volume available easily allows for such a configuration.

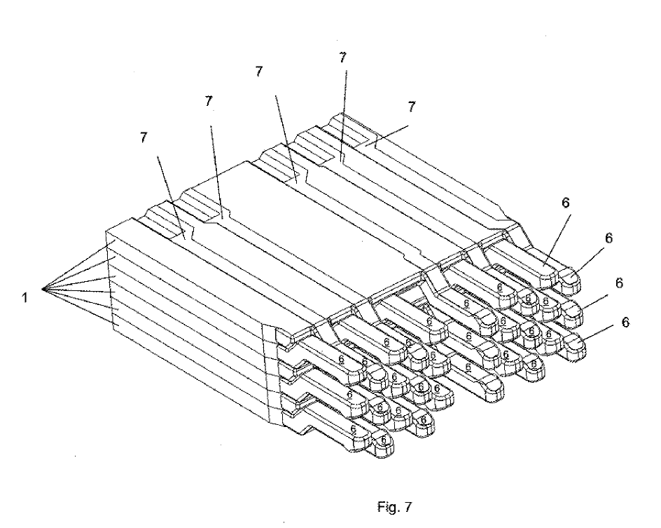

Obviously, the invention is not limited to the embodiments of FIGS. 1 to 4 and other configurations are perfectly possible. It is notably possible to increase the number of nested parts and not be limited to a cruciform configuration (as in FIG. 4), but arrive at star configurations (with three or more nested parts), triangular configurations (“Toblerone” style), rectangular configurations, etc. In another variant, it is also possible to provide a stack of more than two parts 1, for example by stacking the structure 10 of FIG. 3 a number of times (see FIG. 7).

It is also possible to vary the number of fingers 6 used for the contacts.

As will be understood, numerous variants can be envisaged in the context of the present invention.

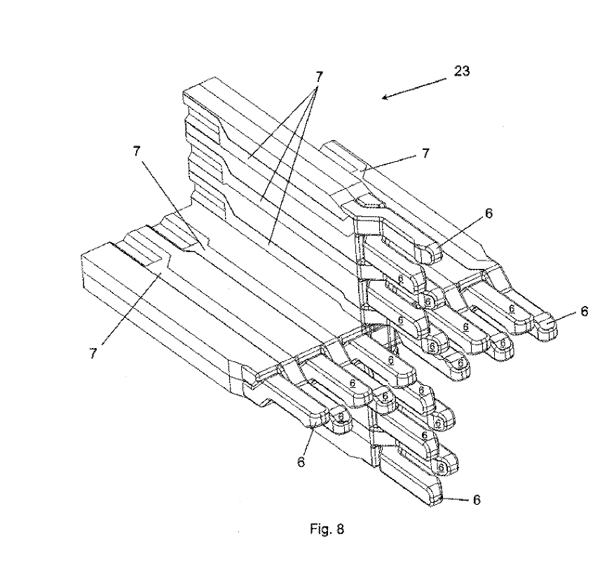

Alternatively, it is possible to start from a more complex structure than that of FIG. 1, for example from a cruciform structure (FIG. 4) or other structure, and to perform the metallization on this more complex structure. Such a structure could be produced by any suitable method (for example molding, prototyping, etc) and the laser activation and the metallization would be applied directly thereto. While this alternative does provide a saving on assembly, it nevertheless presents certain difficulties for the molding. An example of this variant produced in “a block” rather than by assembly is illustrated in FIG. 8. This figure shows a structure 23 which is equivalent to that of FIG. 4 with a cruciform support which bears the tracks 7 and the contact fingers 6. As will be observed by comparison, the embodiment of FIG. 8 is differentiated from that of FIG. 4 also in the frontal alignment of the contact fingers 6: in FIG. 4, the contact fingers 6 in the horizontal plane are set back relative to those in the vertical plane whereas, in FIG. 8, they are all aligned. In the embodiment of FIG. 4, this difference (which is not a defect and may be desired) is due to the nesting of the parts, notably to the form of the slot 9. Obviously, it is perfectly possible, in the context of the present invention, to modify the nesting (for example the slot 9) in such a way that this offset of the contact fingers 6 no longer appears and a version assembled starting from the parts of FIG. 3 is identical or similar to the embodiment illustrated in FIG. 8.

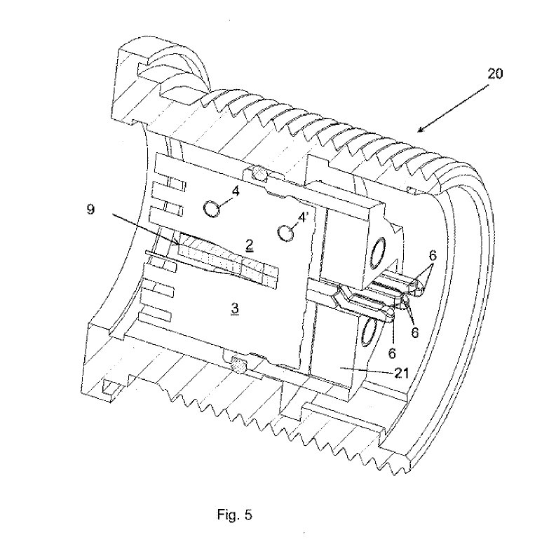

FIG. 5 shows a general cross-sectional view in perspective of an electrical connector 20. According to one embodiment of the invention, the hermaphroditic electrical connector 20 is formed from two parts. The electrical connector system is provided by the flexibility of the contact fingers 6. The design of the contact fingers 6 is particularly studied to ensure an elastic deflection without long term creep. This connector is, for example, a connector which is sealed by screwing.

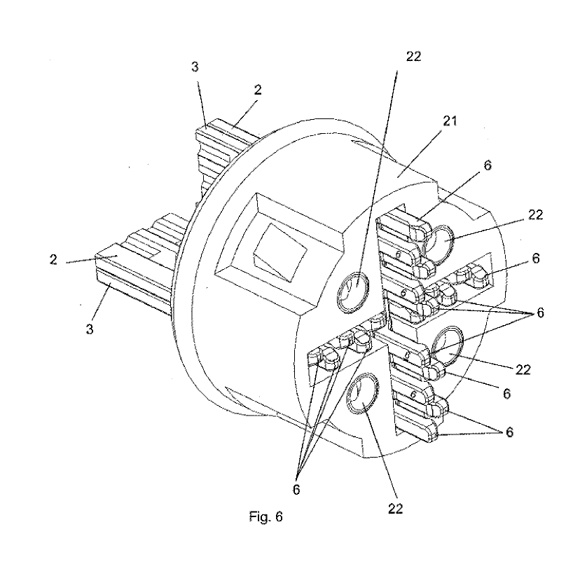

FIG. 6 illustrates a perspective view of a part of the connector of FIG. 5, namely the contact block 21. As illustrated, this block contains a cruciform structure 10 (as a non limiting example, that of FIG. 4) and it also comprises four power contacts 22. This forms a connector with hybrid connection. Given the presence of these four power contacts 22, a cruciform structure is particularly well suited but other configurations are possible, as indicated above.

One of the advantages of the present invention, in addition to its simplicity, is also the fact that the assembled parts 1 are hermaphroditic, that is to say that it can be used both in the male part and in the female part of the connector, hence the significant gain.

As indicated above, the configurations are not limited to those illustrated in the figures by way of examples: the number of fingers for the contacts can be increased or reduced. Any material, preferably non conductive, can be chosen for the parts 1 provided that it can be used in the LPKF-LDS method.

Nor is the LPKF-LDS method the only method that can be used to produce the conductive tracks 7: other equivalent methods can perfectly well be envisaged. This method does, however, present the advantage of simplicity for producing complex tracks on surfaces which are not necessarily planar.

As already mentioned, the nesting is not necessarily limited to the cruciform (90°) configuration, but other angles and a number of nested parts are possible as is a stacking of more than two parts 1, or even triangular or rectangular, or any other desired form.

FIG. 7 illustrates an embodiment in which the parts 1 are stacked one on top of the other. The total number of parts is immaterial and can be chosen according to the circumstances. Preferably, their number is even. Alternatively, this stack can be produced en bloc (for example by molding, prototyping, etc) rather than by the assembly of individual parts 1.

FIG. 8 illustrates another embodiment which has been discussed in detail above.

Obviously, the embodiments described are not exclusive, in other words technical features of one can be applied to another.

Furthermore, the embodiments are illustrative examples which should not be considered to be limiting and variations are possible in the context of the protection claimed, for example by using equivalent means.

Furthermore, as described above, the structures (cruciform, stacked, etc) described above can be produced by the assembly of individual parts (formed by molding or other equivalent method) or else manufactured as a single part (en bloc) by any appropriate method, but it is also possible to envisage a hybrid construction which would be a combination of the two methods: for example, the structure 10 of FIG. 3 would be formed in one piece then two such structures would be assembled to obtain that of FIG. 4 or 8.

The treatment for the metallization (for example according to the method described above) can be performed on individual parts, individual structures or even after the assembly of the parts.

1. A basic part for an electrical connector comprising at least one or more basic parts, said part being non-conductive and comprising fingers and a metal coating applied to said part and the fingers to form tracks and contacts for conveying electricity.

2. The part as claimed in claim 1, characterized in that the basic parts of the electrical connector are identical, planar and asymmetrical.

3. The part as claimed in claim 1, characterized in that the volume generated by said part or the assembly of said parts is a polyhedron.

4. The part as claimed in claim 1, characterized in that the contacts of said part or generated by the assembly of said parts are hermaphroditic.

5. A connector comprising one or a plurality of parts as claimed in claim 1.

6. The connector as claimed in claim 5, in which the assembly of the basic parts forms a cross, a star or a stack.

7. The connector as claimed in claim 5, in which the basic part has the form of a star, cross or stack.

8. A method for forming a basic part as claimed in claim 1, in which said basic part is supplied in a non-conductive material, the areas corresponding to the electrical tracks are activated and said activated areas are metalized.

9. The method as claimed in claim 8, in which the activation is done by laser and the metallization by bath.
